(19) United States
(12) Patent Application Publication
(10) Pub. No.: US 2002/0199107 A1
(43) Pub. Date: Dec. 26, 2002

(54) Methods and appararus for verifying the presence of original data in content

(75) Inventor: Michael A. Epstein, Spring Valley, NY (US)

Correspondence Address: Philips Electronics North America Corp., 580 White Plains Road, Tarrytown, NY, 10591, US

(73) Assignee: Koninklijke Philips Electronics N.V.

(21) Appl. No.: 10/122,802

(22) Filed: Apr. 12, 2002

Related U.S. Application Data
(60) Provisional application No. 60/283,323, filed on Apr. 12, 2001.

(51) Int. Cl. H04L 9/00

(52) U.S. Cl. 713/176

(57) ABSTRACT

Methods and apparatus for verifying the presence of original data in content. The method includes the steps of collecting data associated with the content, evaluating the collected data to verify the presence of original data in the content, and rejecting the content if a number of errors detected during the evaluating step exceeds a threshold number of errors. Certain aspects of the method may vary depending on whether the content is analog or digital. In an illustrative embodiment, a determination is made as to a number of sections of content to evaluate. This determination is preferably a function of a desired level of security. Each of the sections includes a watermark embedded therein which uniquely identifies a corresponding section and contains information which may be used to verify the presence of original data in the content. If the information does not verify correctly, an error counter is incremented. A random binding identification is destroyed if the error counter exceeds a threshold number of errors.

### CROSS REFERENCE TO RELATED APPLICATION

This application claims priority to the U.S. provisional patent application identified by Ser. No. 60/283,323, filed on Apr. 12, 2001, the disclosure of which is incorporated by reference herein.

### FIELD OF THE INVENTION

The present invention relates generally to the field of secure communication, and more particularly to techniques for screening content to verify the presence of original data.

### BACKGROUND OF THE INVENTION

Security is an increasingly important concern in the delivery of music or other types of content over global communication networks such as the Internet. More particularly, the successful implementation of such network-based content delivery systems depends in large part on ensuring that content providers receive appropriate copyright royalties and that the delivered content cannot be pirated or otherwise subjected to unlawful exploitation.

With regard to delivery of music content, a cooperative development effort known as Secure Digital Music Initiative (SDMI) has recently been formed by leading recording industry and technology companies. The goal of SDMI is the development of an open, interoperable architecture for digital music security. This will answer consumer demand for convenient accessibility to quality digital music, while also providing copyright protection so as to protect investment in content development and delivery. SDMI has produced a standard specification for portable music devices, the SDMI Portable Device Specification, Part 1, Version 1.0, 1999, and an amendment thereto issued later that year, each of which are incorporated by reference.

The illicit distribution of copyright material deprives the holder of the copyright legitimate royalties for this material, and could provide the supplier of this illicitly distributed material with gains that encourage continued illicit distributions. In light of the ease of information transfer provided by the Internet, content that is intended to be copy-protected, such as artistic renderings or other material having limited distribution rights, are susceptible to wide-scale illicit distribution. For example, the MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate compact disk (CD), encode the songs into MP3 format, and place the MP3 encoded song on the Internet for wide-scale illicit distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable compact disk for playback on a conventional compact disk player.

A number of schemes have been proposed for limiting the reproduction of copy-protected content. SDMI and others advocate the use of “digital watermarks” to identify authorized content. U.S. Pat. No. 5,933,798, “Detecting a watermark embedded in an information system,” issued Jul. 16, 1997 to Johan P. Linnartz, discloses a technique for watermarking electronic content, and is incorporated by reference herein. As in its paper watermark counterpart, a digital watermark is embedded in the content so as to be detectable, but unobtrusive. An audio playback of a digital music recording containing a watermark, for example, will be substantially indistinguishable from a playback of the same recording without the watermark. A watermark detection device, however, is able to distinguish these two recordings based on the presence or absence of the watermark. Because some content may not be copy-protected and hence may not contain a watermark, the absence of a watermark cannot be used to distinguish legitimate from illegitimate material.

Other copy protection schemes are also available. For example, European Patent No. EP983687A2, “Copy Protection Schemes for Copy-protected Digital Material,” issued Mar. 8, 2000 to Johan P. Linnartz and Johan C. Talstra, presents a technique for the protection of copyright material via the use of a watermark “ticket” that controls the number of times the protected material may be rendered, and is incorporated by reference herein.

An accurate reproduction of watermarked content will cause the watermark to be reproduced in the copy of the watermarked content.

An inaccurate, or lossy reproduction of watermarked content, however, may not provide a reproduction of the watermark in the copy of the content. A number of protection schemes, including those of the SDMI, have taken advantage of this characteristic of lossy reproduction to distinguish legitimate content from illegitimate content, based on the presence or absence of an appropriate watermark. In the SDMI scenario, two types of watermarks are defined: “robust” watermarks, and “fragile” watermarks. A robust watermark is one that is expected to survive a lossy reproduction that is designed to retain a substantial portion of the original content, such as an MP3 encoding of an audio recording. That is, if the reproduction retains sufficient information to allow a reasonable rendering of the original recording, the robust watermark will also be retained. A fragile watermark, on the other hand, is one that is expected to be corrupted by a lossy reproduction or other illicit tampering.

In the SDMI scheme, the presence of a robust watermark indicates that the content is copy-protected, and the absence or corruption of a corresponding fragile watermark when a robust watermark is present indicates that the copy-protected content has been tampered with in some manner. An SDMI compliant device is configured to refuse to render watermarked material with a corrupted watermark, or with a detected robust watermark but an absent fragile watermark, except if the corruption or absence of the watermark is justified by an “SDMI-certified” process, such as an SDMI compression of copy-protected content for use on a portable player. For ease of reference and understanding, the term “render” is used herein to include any processing or transferring of the content, such as playing, recording, converting, validating, storing, loading, and the like. This scheme serves to limit the distribution of content via MP3 or other compression techniques, but does not affect the distribution of counterfeit unaltered (uncompressed) reproductions of content material. This limited protection is deemed commercially viable, because the cost and inconvenience of downloading an extremely large file to obtain a song will tend to discourage the theft of uncompressed content.

Copending U.S. patent application Ser. No. 09/537,815, entitled “Protecting content from illicit reproduction by proof of existence of a complete data set,” and filed on Mar. 28, 2000 in the name of inventor Michael Epstein (hereinafter referred to as the '815 application), incorporated by reference herein, teaches selecting and binding data items to a data set that is sized sufficiently large so as to discourage a transmission of the data set via a bandwidth limited communications system, such as the Internet. The '815 application teaches a binding of the data items in the data set by creating a watermark that contains a data-set-entirety parameter and embedding this watermark into each section of each data item. The '815 application also teaches including a section-specific parameter (a random number assigned to each section) in the watermark. The '815 application teaches the use of “out of band data” to contain the entirety parameter, or information that can be used to determine the entirety parameter. The section watermarks are compared to this entirety parameter to ensure that they are the same sections that were used to create the data set and the entirety parameter. To minimize the likelihood of forgery, the entirety parameter is based on a hash of a composite of section-specific identifiers.

Copending U.S. patent application Ser. No. 09/537,079, entitled “Protecting content from illicit reproduction by proof of existence of a complete data set via a linked list,” and filed Mar. 28, 2000 in the name of inventors Antonius Staring et al. (hereinafter referred to as the '079 application), incorporated by reference herein, teaches a self-referential data set that facilitates the determination of whether the entirety of the data set is present, without the use of out of band data and without the use of cryptographic functions, such as a hash function. The '079 application creates a linked list of sections of a data set, encodes the link address as a watermark of each section, and verifies the presence of the entirety of the data set by verifying the presence of the linked-to sections of some or all of the sections of the data set.

Copending U.S. patent application Ser. No. 09/536,944, entitled “Protecting content from illicit reproduction by proof of existence of a complete data set via self-referencing sections,” filed Mar. 28, 2000 in the name of inventors Antonius Staring et al. (hereinafter referred to as the '944 application), incorporated by reference herein, addresses the illicit distribution of select content material from a collection of copy protected content material. Often, a song is “ripped” from a compact disk and illicitly made available for distribution via the Internet. Each subsequent download of the song deprives the owner of the copyrights to the song of rightful royalties. A premise of this copending patent application is that the downloading of a song will be discouraged if the user is required to also download the entire contents of the compact disk. That is, due to bandwidth limitations and other factors, the illicit download of an entire compact disk is deemed to be substantially less likely than the illicit download of an individual song.

To verify that an entirety of the collection of content material is present when a particular song is presented for rendering, a compliant rendering device accesses other segments of the collection, to verify their presence. To assure that these other sections belong to the same compact disk, an identifier in the watermark of each segment of the compact disk is bound to the segment.

Since the step of reading a watermark has a cost, if the watermark is not analyzed via an efficient algorithm, the computation cost will be higher than it would be if the algorithm was efficient. Thus, a need still exists for an efficient algorithm which is designed to screen an entire compact disk or other type of content to verify the presence of original data.

### SUMMARY OF THE INVENTION

The present invention provides methods and apparatus for verifying the presence of original data while copying or otherwise processing an entire compact disk or other content. More specifically, in an illustrative embodiment, the present invention provides a method for verifying the presence of original audio data while copying an entire compact disk.

In accordance with one aspect of the present invention, a method of verifying the presence of original data in content which includes the steps of collecting data associated with the content, evaluating the collected data to verify the presence of original data in the content, and rejecting the content if a number of errors detected during the evaluating step exceeds a threshold number of errors. Certain aspects of the method may vary depending on whether the content is analog or digital.

In accordance with another aspect of the invention, a determination is made as to a number of sections of content to evaluate. This determination is primarily a function of a desired level of security.

In another aspect of the invention, the data is separated into at least two sections wherein each of the at least two sections includes a watermark embedded in each of the sections. The watermark uniquely identifies a corresponding section and contains information which may be used to verify the presence of original data in the content. For example, the watermarks may contain a copy-never message, a section identification number and/or a compact disk identification number. If the information does not verify correctly, an error counter is incremented and the watermark is marked as unused. Additionally, a random binding identification associated with the content is destroyed if the error counter exceeds a threshold number of errors.

To ensure that the verification process was legitimate, a predetermined number of watermarks should be evaluated. If the number of watermarks that were evaluated is less than a predetermined number, then a retry algorithm is implemented to collect additional data.

These and other features and advantages of the present invention will become more apparent from the accompanying drawings and the following detailed description.

### BRIEF DESCRIPTION OF THE DRAWINGS

FIG. 1 is a flow diagram illustrating the components of a method of verifying the presence of original data in content in accordance with an embodiment of the present invention;

FIG. 2 is a flow diagram illustrating elements of the pre-work component of the FIG. 1 method in accordance with the present invention;

FIG. 3 is a flow diagram illustrating elements of the data collection component of the FIG. 1 method in accordance with the present invention;

FIG. 4 is a flow diagram illustrating elements of the data evaluation component of the FIG. 1 method in accordance with the present invention;

FIG. 5 is a flow diagram illustrating additional elements of the data evaluation component of the FIG. 1 method in accordance with the present invention;

FIG. 6 is a flow diagram illustrating a method of comparing each number in a set to other numbers in the set to determine whether all numbers in the set are the same;

FIG. 7 illustrates an example system for verifying the presence of original data in content in accordance with the invention; and

FIG. 8 is a block diagram illustrating a processing device suitable for use in an embodiment of the present invention.

### DETAILED DESCRIPTION OF THE INVENTION

The present invention is designed to prove the existence of a complete data set by analyzing only parts of the content. One such circumstance that may occur is the recording/compressing/“ripping” of an entire compact disk while listening to a single song. The algorithm analyzes the correctness of watermarks contained in the content and allows or disallows the user to record/compress/“rip” the disk.

The present invention in an illustrative embodiment provides a method (also referred to herein as an “algorithm”) for verifying the presence of original audio data while copying an entire compact disk. More specifically, the method in the illustrative embodiment prevents the unauthorized use of content which is incomplete or otherwise altered by a user. If the method determines that the content contains a sufficient number of errors which indicate that the content is incomplete or has been tampered with, the user is prevented from being able to access the content by randomly binding and/or destroying the content. Advantageously, the method in accordance with an embodiment of the present invention compensates for errors in recovering watermarks from content. Conventional techniques assumed that the watermark system is essentially perfect.

For ease of understanding, the invention is presented herein in the context of digitally recorded songs. As will be evident to one of ordinary skill in the art, the invention is applicable to any recorded information that is expected to be transmitted via a limited bandwidth communications path. For example, the individual items within the content may be data records in a larger database, rather than songs of a compact disk. Additionally, this invention is presented hereinafter in the context of a copy-protected compact disk that is organized into finite-length segments, although the principles of this invention are not limited to this particular media.

The present invention is based, at least in part, on the premise that the theft of an item can be discouraged by making the theft more time consuming or inconvenient than the worth of the stolen item. For example, a bolted-down safe is often used to protect small valuables, because the effort required to steal the safe will typically exceed the gain that can be expected by stealing the safe. However, notwithstanding the goal of protecting the desired item, provisions must be considered where the means of protection make it too difficult for the legitimate owner to access the protected item.

In an illustrative embodiment of the invention, it is presumed that each section of a data set is uniquely identified and this unique identifier is encoded as a watermark that is embedded in the section. To ensure that a collection of sections are all from the same data set, an identifier of the data set is also encoded as a watermark that is embedded in each section. Using exhaustive or random sampling, the presence of the entirety of the data set is determined, either absolutely or with statistical certainty. If the entirety of the data set is not present, subsequent processing of the data items of the data set is terminated. In the context of digital audio recordings, a compliant playback or recording device is configured to refuse to render an individual song in the absence of the entire contents of the compact disk. The time required to download an entire compact disk in uncompressed digital form, even at DSL and cable modem speeds, can be expected to be greater than an hour, depending upon network loading and other factors. Thus, by requiring that the entire contents of the compact disk be present, at a download “cost” of over an hour, the likelihood of a theft of a song via a wide-scale distribution on the Internet is substantially reduced.

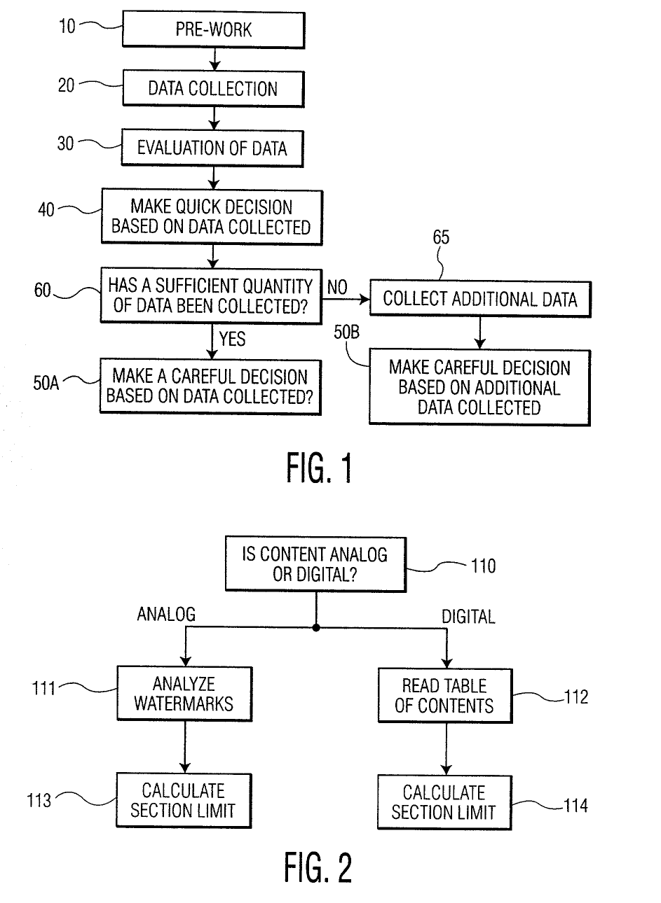

Referring now to the drawings in detail, and initially to FIG. 1, there are five major components to the method in the illustrative embodiment of the present invention. The five components include a pre-work component 10, a data collection component 20, a data evaluation component 30, a quick decision component 40 and careful decision components 50A and 50B. It is within the decision components that a determination is made as to whether the content should be accepted or rejected.

Additionally, subsequent to the quick decision component 40, in step 60 the algorithm determines whether a sufficient number of watermarks were considered during the quick decision. If it is determined, in step 60, that a sufficient number of watermarks were considered, then the algorithm will make a careful decision based on the data that has been collected, as illustrated in step 50A. If a sufficient number of watermarks were not considered, additional watermarks will be obtained and analyzed, as illustrated in step 65. After additional data has been collected, a careful decision will be made, in step 50B.

Referring now to FIG. 2, in a preferred embodiment of the present invention, the first step 110 of the pre-work component 10 is to check to determine whether the content to be downloaded is analog or digital. If the content is analog, a particular protocol must be applied, which is different than the protocol that is applied to digital content. A different protocol is applied to the different types of content primarily due to the fact that a section limit may only be computed if the content is digital. If the content is received via analog means, the Table of Contents (TOC) will be unavailable and the section limit must be calculated in step 113 from an analysis of the watermarks in step 111.

If the content is digital, the next step 112 is to read the TOC into memory. This information will be utilized as a reference point, as will be described below. A section limit is calculated in step 114 by taking the run time of a track in the content and dividing the run time by a section duration. The section limit is preferably expressed as an integer since any fractional amount will not have a watermark and is, therefore, not part of the analysis. For example, if a song is three minutes long, it will have twelve watermark sections in it, assuming that the section duration is set at 15 seconds. If the song is three minutes and one second long, then the song will contain twelve watermarks and one second that is not watermarked. The watermarks are organized with a section limit, a section number and a Compact Disk Identification (CDID) number. The section limit will be used to check other aspects of the watermarks.

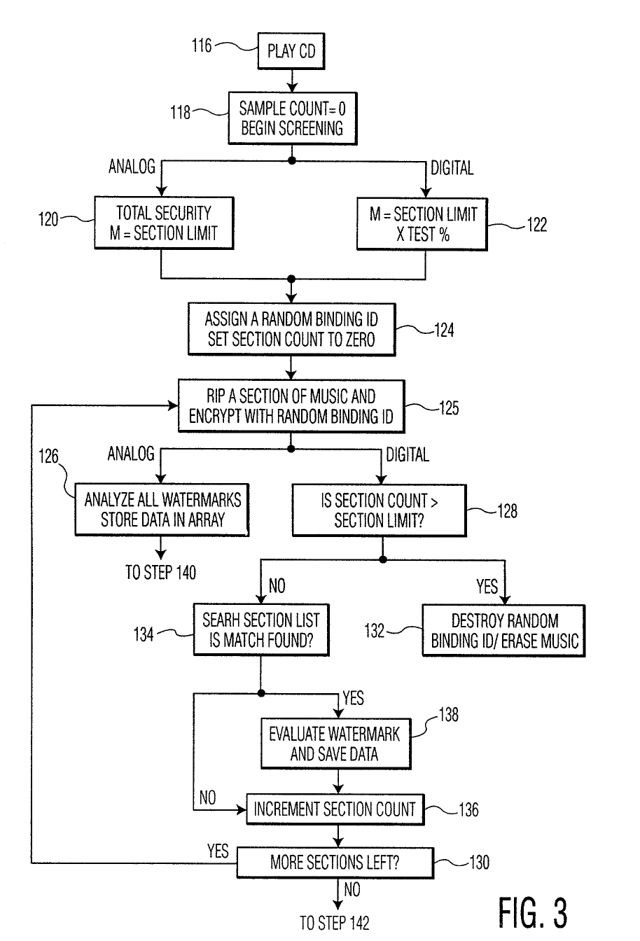

Upon entering the data collection component 20 and referring now to FIG. 3, the first step 116 is to start playing the song on the compact disk. The song may be any track on the disk. In step 118, a sample count is set to zero and the algorithm begins screening the content, one sample at a time. It is assumed that all of the music will pass through the algorithm whether it is analog or digital. The compact disk does not need to be played in “real time” which would allow the music to be heard. Rather, the compact disk will likely be played at four times or even twenty-four times faster than “real time”.

The next step is to pre-select a number of random sections M, since some but not all of the sections will be evaluated. The sections must be pre-selected to ensure that the selection is random and not otherwise influenced. The number of sections to be chosen depends on whether the content is analog or digital and the desired level of security. If the content is analog, the only level of security that may be chosen is total security where every section is checked. If the content is digital, the algorithm may choose between several different levels of security. For example, the level of security may dictate that any one of 25%, 50% or 100% of the sections is checked.

More specifically, assuming that the content contains 152 sections and the content is analog, thus requiring a selection of total security, in step 120, the algorithm will set M equal to the number of sections gathered. It is expected that at the end of the data gathering component that every watermark on the compact disk has been read and all 152 sections will be evaluated. The desired section identification (ID) starts at one and proceeds through to 152. This will result in an array of numbers corresponding to every section.

Alternatively, if the content is digital, then in step 122, the algorithm sets M equal to the section limit multiplied by a desired test percentage. In this case, the section ID numbers are computed and are arranged to include pseudo random numbers between one and the section limit, without allowing duplicates. The numbers may be selected and put into an array to ensure that there are no duplicates.

The next step 124 assigns a random binding ID to the individual sections to encrypt the content. Generally, the random binding step 124 uses a random number generator and key generation algorithm to generate a random binding ID which is preferably a 128 bit number. The section count is also set to zero.

In step 125, the selected track (song) is played and the entire compact disk is ripped. While the end of the compact disk is not found the algorithm proceeds through a series of steps. First, the music is ripped from the compact disk and bound to the random binding ID. It is contemplated that partial encryption of compressed music is sufficient. That is, the algorithm encrypts the music with the random binding ID. If this encrypting step 125 is not undone, the music which was ripped and bound to the random binding ID (i.e., encrypted) will not be comprehensible. Thus if the process terminates abnormally the “ripped/” music will be useless. The section count is then incremented by one section. Again, if the content is analog, the algorithm will evaluate all of the sections.

Evaluation of the watermark yields information, such as the section ID, the section limit and the CDID. The watermark also indicates whether the compact disk is marked as “copy-never.”

Diagnostic information indicates whether the watermark exists. Sometimes a search for a watermark will indicate that a watermark could not be found. If the algorithm does not find a watermark then the other payloads are irrelevant because it is the watermark that provides the necessary information. If the watermark is found, then all watermark information is recorded.

Returning now to the case where the content is analog, as discussed above, all sections will be evaluated. The algorithm is ripping a whole disk from an analog source. Ripping stops when the entire disk has been played. Since the content is being recorded in the analog domain, the algorithm does not have control of the disk. That is, where the content is analog, the algorithm cannot skip around to various songs on the disk, start and stop the disk and access the table of contents. Therefore, where the content is analog, the algorithm reads the watermarks to see if they are inherently consistent. Basically this process may be achieved by reading every single watermark and checking to see how they compare. That is, did all of the watermarks come from the same disk, did the algorithm not miss a lot of watermarks and so forth. Evaluating all of the watermarks is important because if any of the watermarks say copy-never, then the whole disk is copy-never and any other allegedly legitimate part is likely an attempt to download illicit material. For example, an adulteration attack may have been attempted wherein good content has been added to illicit content and the algorithm would need to analyze an entire disk to find one song with a section that says copy-never. That may be the song that an attacker may be trying to smuggle in. To be effective, the algorithm must be capable of anticipating at least the most common ways of attacking a screening algorithm. When in the total security mode (which is effectively the scope of the analysis when analyzing analog content), the algorithm will detect an attempted adulteration attack. See, for example, copending U.S. patent application Ser. No. 09/966,435, entitled “Methods of attack on a content screening algorithm based on adulteration of marked content,” filed Sep. 28, 2001, and hereby incorporated by reference herein.

Analyzing content while in the total security mode is a slow procedure. However, it tends not to be a performance issue because people record analog at one times the speed of the drive, i.e., real time (analog content is not run at high speeds, to prevent distorting the sound output). Digital content may be recorded at rates of twenty times the speed of the drive. In summary, as shown in step 126, when analyzing the analog sections, the algorithm evaluates the watermarks in all of the sections and stores the data in an array for future analysis.

If the content is digital, a different method of gathering data occurs. The first step 128 is to determine whether the section count is greater than the section limit which was previously calculated based on the table of contents. Since the content is digital, the table of contents is a known entity. That is, the number of sections on the disk may be computed from the table of contents based on a fixed algorithm as is known to one having ordinary skill in the art. If it is determined that the whole disk contains more sections than there are on the table of contents, it is safe to assume that the disk has been tampered with. In this case, as shown in step 132 the algorithm physically destroys the random binding ID and then attempts to erase all of the music that has been ripped so far. In some cases, an attacker attempts to run the attack program to partially recover the content. That is, the attacker will run the attack program part way and then try to turn it off early and in an attempt to recover as much of the content as possible. However, destroying the random binding ID is so fast that, in most cases, it prevents this type of attack.

The algorithm utilizes a random binding ID which is preferably a random key. The key is chosen completely at random to encrypt material and the algorithm keeps encrypting the material as it is ripped from the compact disk and onto the hard drive. Therefore, if something disrupts the algorithm during this encryption step, the attacker cannot decrypt the content since it has been encrypted with a random binding ID. Advantageously, partial results are never available, so that the attacker is not able to obtain part of a disk. Although a disruption of the algorithm is just one example of a potential attack being made on protected content, whenever the algorithm detects an indication that an attack of any form is being made, the random binding ID is destroyed. Destruction of the random binding ID occurs very quickly and then the algorithm attempts to destroy the music as well. If the attacker is very quick, the attacker might be able to stop the algorithm from destroying all of the music because that will take some time. However, stopping the algorithm from destroying the random binding ID can be difficult since the entire process typically only involves a limited number of instructions.

In a preferred embodiment of the algorithm in accordance with the present invention, M is equal to the number of preselected sections. As described above, it would be preferable to evaluate some, but not all, of the sections in the compact disk. However, this is not practical in the case where the compact disk is analog. The amount of sections to evaluate is more of a concern when the compact disk is digital and higher speeds and better performance are more at issue. However, for the total security case, the evaluation time for analog and digital recordings are the same.

If the section count does not exceed the section limit, then the algorithm begins to search through the whole list of sections collected and determine whether there is a match to a desired section in step 134. Since the list is in arbitrary order, the algorithm will search down until it finds one that matches.

If the algorithm finds a match, it evaluates the watermark and saves all of the corresponding data in step 138. This data consists of a section limit, a section ID, and a CDID. The watermark may also contain a copy never bit indicating that this content should never be copied. At times, the watermark will not be recoverable. For example, the music content may not allow the watermark to be recovered or damage may have affected the compact disk.

If the watermark does not exist, a bit indicating that the watermark does not exist is stored and the other information is ignored. Finally, once the watermark has been evaluated, the section count is incremented in step 136 and the algorithm returns to the main loop in step 130 to rip another section, if there is another section to evaluate. If a match is not found, the section count will be incremented in step 136, and the algorithm returns to the main loop in step 130 to rip another section, if there is another section to evaluate.

Once every section that is needed has been ripped, all necessary data has been gathered. For an analog recording the user is required to use the loop function of the compact disk player so that the entire disc is played once through from the beginning.

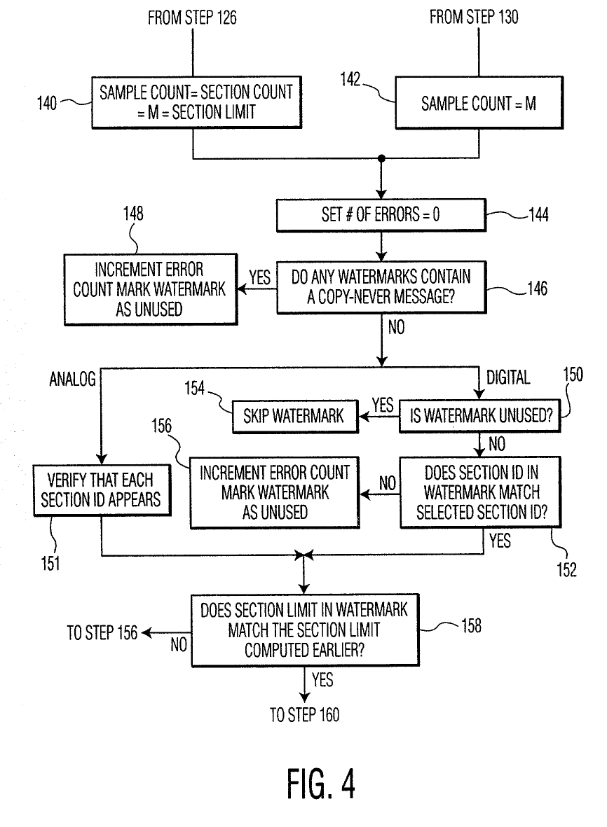

Referring now to FIG. 4, in the next component of the algorithm, the algorithm determines whether the information obtained from the watermarks indicate a pass or fail grade. The algorithm then sets a number of variables in steps 140 and 142. If the input is analog we set the sample count equal to the section count, M is set equal to the section count and the section limit is set equal the section count. If the input is digital then the sample count is set equal to M. The purpose of setting the variables is to adjust some parameters that may be used as a reference point at a later time.

Generally, the algorithm then proceeds through a series of checks of the data and determines whether any errors exist in the data. First, in step 144, the number of errors found is set equal to zero and then the algorithm proceeds through a plurality of checks. During this procedure, a counter keeps track of the number of errors found. After all the checks are complete the number of errors that occurred can be compared to a predetermined number of errors. A certain predetermined number of errors are accepted since, for example, the compact disk may have imperfections thereon, it may be scratched or otherwise damaged, and watermarks are imperfect. In determining an acceptable number of errors, a balance must be struck between concerns, such as, (1) if the algorithm accepts too many errors an attacker may circumvent the algorithm by, for example, adulteration attacks and (2) if the algorithm accepts too few errors the reliability of the system will not be good enough for the ordinary consumer. For example, the music may be rejected because of a scratched disk or because the music is difficult to watermark. Music is inherently difficult to watermark when it is too quiet. For example, a classical piece containing a single piano with a lot of silence is difficult to watermark.

The next step 146 for the algorithm is to go through the entire list of watermarks and determine whether any of the watermarks contained the bit indicating that the content was marked as copy never. For every watermark that exists, the algorithm evaluates whether there is a copy never message. When a copy never message is found, the error count is incremented and the corresponding watermark is tagged as unused, as shown in step 148. However, it is possible that a faulty reading of the watermark occurred.

If no watermark is found in a section of the content, there is nothing for the algorithm to evaluate. Naturally, there is some suspicion if the watermark does not exist. Later in the procedure the level of the suspicions is evaluated and appropriate steps are taken.

Whenever a watermark is found, it is also evaluated, for example in step 150, to determine whether it has been marked as unused. As shown in step 154, if the watermark is marked unused, the algorithm will select the next watermark to be evaluated. The algorithm maintains an array of items which have been marked as unused. The purpose of the array is to keep track of watermarks which were previously determined to contain errors so that that same watermark is not double counted thereby counting a single error multiple times. Thus, every time the algorithm increments the counter for the number of errors found, the watermark containing the error is marked as unused.

If the content is digital, the algorithm checks, in step 152, to determine whether the section ID contained in every watermark matches the selected section ID. First, the algorithm checks to determine whether the watermark is marked unused. If the watermark exists and is not marked unused, and the desired section ID does not match the section ID inside the watermark, then that is an error. Accordingly, the watermark will be marked unused and the number of errors will be incremented as shown in step 156.

If the content is analog, in step 151 the algorithm verifies that every section ID has appeared in order. Unused or missing watermarks are ignored. If a section ID is not found in the expected location, the error count is incremented and that watermark is designated as unused for the remainder of the checking.

Next, in step 158, the algorithm checks to determine whether the section limits are consistent with the computed section limit. If the section limit in any watermark disagrees with the section limit previously computed, then the error count is incremented and that watermark is marked as unused.

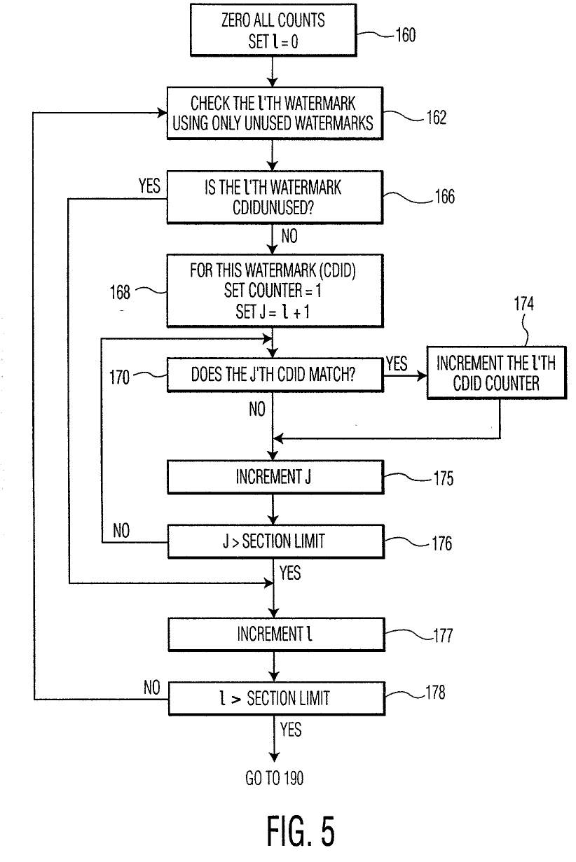

The purpose of the next series of steps is to make sure that all of the CDIDs are the same as each other. The CDID comparison process is complicated by the fact that the CDID related to the compact disk being ripped is not known. The problem is resolved by the algorithm illustrated in FIG. 5.

At this point in the overall process, the watermarks have been evaluated for a number of identifiers, some of which are now known to be correct. Therefore, now it should be true that, for the watermarks that have been determined to not contain any errors, since the CDID is unique to each compact disk, all of the watermarks on the compact disk should be the same. However, as stated above, the precise CDID is not known. If the compact disk is perfect, the algorithm could simply take the first CDID that is found and compare all of the other CDIDs to that CDID to see if all of the CDIDs are the same. However, if even one error is allowed, then a simple algorithm like that cannot be used since the first CDID that is encountered may also be incorrect. Therefore, such a more complex procedure has been created in accordance with the present invention as follows.

Referring to FIG. 5, an algorithm is illustrated in accordance with the present invention to compare one number with other numbers. The first step 160 is to zero all counts and set the index I to zero. Potentially there is a count for each watermark gathered. Advantageously, this step eliminates the need for an expensive IF statement within the algorithm. Next, the algorithm proceeds through all of the watermarks in step 162 and checks to see if they are marked unused. As described above, the watermark will be marked unused if the watermark contained an error. Once there is an error associated with a watermark, it is likely that the whole watermark is corrupted. It is not desirable to double count the error.

The algorithm then, in step 166, evaluates the I'th watermark to determine whether the watermark have been previously marked unused from the CDID perspective (CDIDunused). If this watermark is marked CDIDunused, it has already been accounted for and no further work is necessary. The index I is incremented in step 177 and checked to determine whether it exceeds the section limit in step 178. If the section limit is exceeded by index I then all CDIDs have been counted and the algorithm proceeds to the next step.

If the watermark is still available for use, in step 168 the CDID count is set to one. This means that one CDID of this value has been found. That is, it found itself. Also, the index J is set to I plus one. Then, in step 170, the algorithm will check each of the remaining watermarks on the list (from I+1 to the section limit) to determine whether a matching CDID can be found. If a matching CDID is found, the counter for the selected CDID is incremented in step 174. The J'th watermark is then marked as CDIDunused. If the CDIDs do not match, the algorithm continues comparing CDIDs via the loop shown in steps 170 through 176. In other words, the first thing that the algorithm is doing is taking the first CDID that is found that is not unused or CDID unused and comparing that first CDID to each of the other CDIDs to determine whether there is a match. For example, assume that there are 20 CDIDs. The algorithm takes the first CDID and compares it to all of the remaining 19 CDIDs and each time a match is found, the algorithm marks the one that it is looking at, as CDIDunused and increments the count for the first CDID. The count is then incremented. Assuming that the algorithm starts with i equals 0 and proceeds through 19 other CDIDs finding three matches which are marked as unused. Now the CDID count for the first CDID is equal to four—the one being compared to the rest plus the three matches.

After the matches have been found, the next unused watermark is compared with the remaining watermarks. More specifically, the algorithm looks to the second CDID to determine whether it has been a marked as CDIDunused. If it has been marked as CDIDunused (i.e., it was previously counted), then the algorithm will skip to the next CDID. If this CDID is not marked CDIDunused then the algorithm assigns a count of one (1) and checks the next 18. This process continues until all of the CDIDs numbers have been exhausted. During this comparison process, the algorithm prepares a list of counts and the CDID associated with each of those counts.

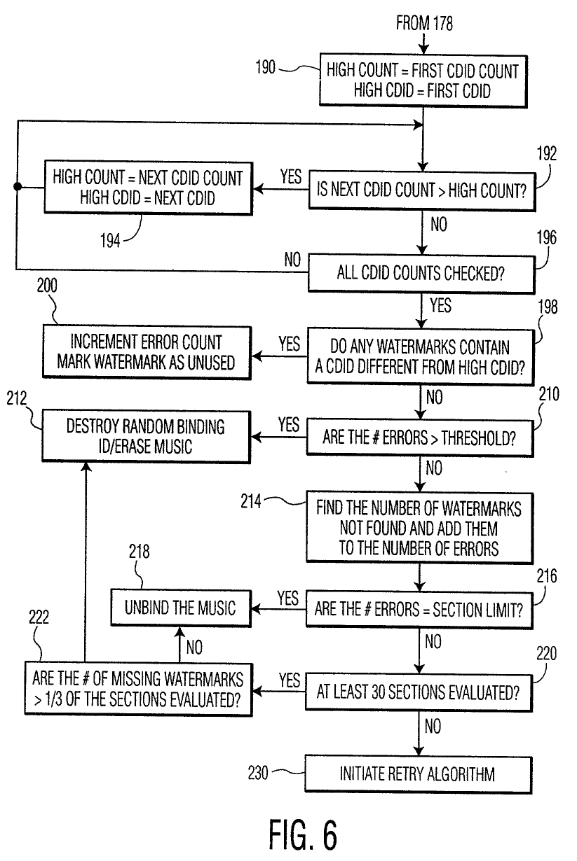

Referring now to FIG. 6, the next portion of the algorithm is directed to determining the most popular CDID number. The algorithm starts off with a high count equal to the first CDID count, and keep the corresponding CDID value as the high CDID in step 190. The term “count” refers to a number of matches of the particular CDID. While proceeding through the CDIDs in step 192, if the any count is higher, then the algorithm will change the count value and change the high CDID to the CDID corresponding to the higher count in step 194. The algorithm proceeds to the next portion of the algorithm after all CDIDs have been examined, as indicated in step 196. Having found the highest count, the algorithm has also found a CDID that is more “popular” than any other CDID.

Now the algorithm makes one last pass through the watermarks and the high CDID is compared against all of the other CDIDs and each one that disagrees is in error and the algorithm increments the error count in steps 198 and 200.

Now that all of the errors have been accumulated (i.e., the wrong CDIDs, the wrong count, the wrong limits, etc.), in step 210, the number of errors is compared against a threshold value to determine whether more errors were uncovered than the threshold value. If the number of errors found is greater than the threshold value, in step 212, the algorithm destroys the random binding ID and the attacker will not be able to use any of the content.

If there are not enough errors to cause destruction of the music the number of “errors” is set equal to the number of watermarks that are not found plus the number of errors. That is, the algorithm will check to see if any watermarks were found. In one situation, there may be no errors associated with music if a watermark did not exist. Therefore, if there is no watermark to evaluate, such as, e.g., for unmarked music, an error cannot be generated. A watermark may never be found.

At the same time, the algorithm will attempt to determine how many watermarks that could not be found because perhaps an attacker is manipulating the content such as, for example, by adulterating the content. For example, if 50 checks were made and only three similar watermarks were found and the content was permitted to be downloaded based on those three watermarks alone, that would not likely be an accurate indication that the whole compact disk is legitimate. Therefore, in step 214 the number of watermarks which were not found are added to the number of errors. Now that all of the missing watermarks have been accounted for, the results must be evaluated. For example, what if the number of “errors,” which is most likely the number of missing watermarks, is equal to M, thereby indicating that every section which was tested contains an error, and every section was checked in step 216. A statement that every single one is a mistake is virtually impossible. That is, if the algorithm found any watermarks whatsoever, it would have found them to be consistent. The compact disk may have been marked as copy never, but that would have been detected earlier. A compact disk marked as copy never would not have passed the error threshold value. That is, if the disk is not marked, it is legacy. If every single watermark that is checked does not exist or it has an error, it is likely that the disk is a legacy disk. At that point, the algorithm will unbind the music, thereby allowing the music to be used in step 218.

In another scenario, what if the algorithm indicates that not all of the watermarks are missing and there have not been sufficient errors to reject the music. Therefore the algorithm must determine whether a sufficient number of watermarks have been evaluated to make a decision. As indicated in step 220, if at least 30 sections of music have been checked, a quick decision may be made. In step 222 it is verified that the number of watermarks missing is greater than one third of the checked sections. If so, the algorithm will consider that a failure and will destroy the random binding ID and the music in step 212. If the number of missing watermarks is less than one-third of the checked selections, the algorithm will unbind the music in step 218 and will permit the content to be downloaded. Statistics indicate that those numbers will provide acceptable results given the accuracy of the watermark software that exist today.

If the compact disk did not contain at least 30 watermarks the algorithm will initiate another algorithm called retry in step 230. The retry algorithm is described more fully in U.S. patent application Ser. No. 09/969,004, filed Oct. 2, 2001 and entitled “Copy protection via multiple tests,” which is incorporated by reference herein. Generally, the retry algorithm is initiated if there are less than 30 watermarks. Statistically, less than thirty watermarks is an indication that there are not enough watermarks to make a reliable decision. The retry algorithm will take the watermarks that have been identified so far and start all over again. The retry algorithm starts going through the watermarks accumulated so far and if the algorithm finds a run of successful watermarks the minimum amount of watermarks necessary (the run length depends on several parameters) should be obtained. If such a run is obtained the content is accepted unbound from the random binding ID. If not, the retry algorithm will continue to look for more watermarks. At some point the watermarks accumulated may be exhausted without accepting or rejecting the music. In that case, the algorithm will randomly get additional watermarks. Preferably, the algorithm will access the disk and go to an arbitrary place and pick another watermark. If the real problem is with the watermarking reading software (i.e., that the software cannot read the watermark successfully) the algorithm will give the software additional chances to be successful. Each new piece of data will be checked for consistency (e.g., for errors) with the watermarks that were accumulated previously.

The foregoing gathering of additional data is only possible in the digital case. If the content was received in an analog fashion no additional data may be obtained and the content is rejected by destroying the binding ID and the music.

The retry algorithm will use either accumulated watermarks or possible additional watermarks in an attempt to accept the data. However at some point if a successful run is not found the retry algorithm will give up and destroy the random binding ID and the music.

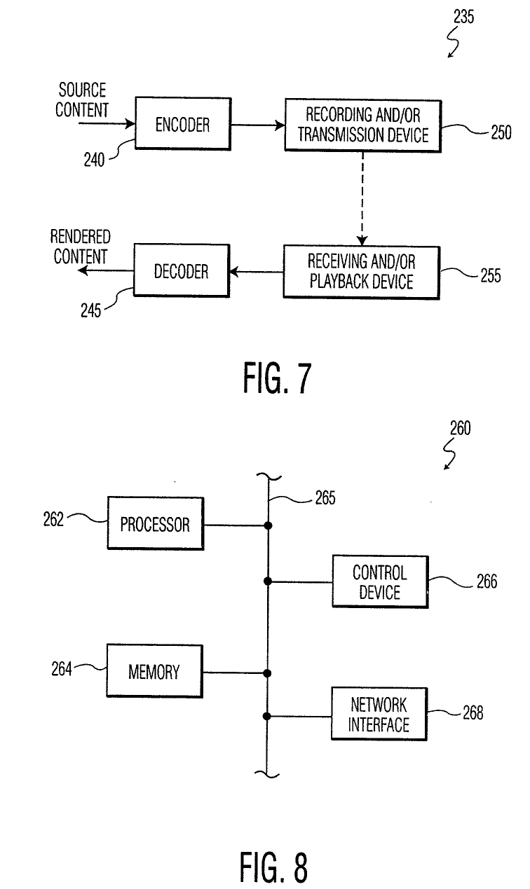

FIG. 7 illustrates a block diagram of an example system 235 that verifies the presence of original data in content. The system 235 comprises an encoder 240 that encodes source content material, and a decoder 245 that renders the encoded content material. A recording and/or transmission device 250 records the encoded content material onto a medium or configures it for transmission using techniques common in the art.

The decoder 245 in accordance with this invention is configured to receive information from a receiving and/or playback device 255, which may be an independent device, a component of a multimedia system, a solid-state or disk memory device, a CD reader, etc. The dotted lines of FIG. 7 illustrate that the content may be transferred from device 250 to device 255 via a direct connection, such as a network connection, by transferring a disk from device 250 to device 255, or by other suitable arrangements.

The decoder 245 uses the inspection method described herein to prevent final use of the downloaded content unless the entire compact disk is present.

FIG. 8 shows an example of a processing device 260 that may be used to implement, e.g., a program for executing the method of verifying the presence of original audio data while copying an entire compact disk described above. The device 260 may correspond to one or more of the elements 240, 245, 250 and 255 of FIG. 7. The device 260 includes a processor 262 and a memory 264 which communicate over at least a portion of a set 265 of one or more system buses. Also utilizing at least a portion of the set 265 of system buses are a control device 266 and a network interface device 268. The processing device 260 may represent, e.g., portions or combinations of a desktop computer or any other type of processing device for use in implementing at least a portion of the method in accordance with the present invention. The elements of the processing device 260 may correspond to conventional elements of such devices.

For example, the processor 262 may represent a microprocessor, central processing unit (CPU), digital signal processor (DSP), or application-specific integrated circuit (ASIC), as well as portions or combinations of these and other processing devices. The memory 264 is typically an electronic memory, but may comprise or include other types of storage devices, such as disk-based optical or magnetic memory. The control device 266 may be associated with the processor 262. The control device 266 may be further configured to transmit control signals.

The methods described herein may be implemented in whole or in part using software stored and executed using the respective memory and processor elements of the device 260. For example, the method of verifying the presence of original audio data may be implemented at least in part using one or more software programs stored in memory 264 and executed by processor 262. The particular manner in which such software programs may be stored and executed in device elements such as memory 264 and processor 262 is well understood in the art and therefore not described in detail herein.

The above-described embodiments of the invention are intended to be illustrative only. Numerous alternative embodiments within the scope of the following claims will be apparent to those skilled in the art.

What is claimed is:

1. A method of verifying the presence of original data in content, the method comprising the steps of:
collecting data associated with the content;
evaluating the collected data to verify the presence of original data in the content; and
rejecting the content if a number of errors detected during the evaluating step exceeds a threshold number of errors.

2. The method of claim 1, further comprising the step of determining whether the content is analog or digital.

3. The method of claim 1, further comprising the step of determining the quantity of data that has been collected.

4. The method of claim 3, further comprising the step of collecting additional data if the quantity of data that has been collected is determined to be less than a predetermined quantity of data.

5. The method of claim 1, further comprising the step of determining a number of sections of the content to evaluate.

6. The method of claim 5, wherein the content is digital content and the number of sections of content to evaluate is a function of a desired level of security.

7. The method of claim 1, further comprising the step of assigning a random binding identification number to individual sections of the content.

8. The method of claim 1, further comprising the step of ripping at least a portion of the content.

9. The method of claim 8, further comprising the step of binding the portion of the content to a random binding identification.

10. The method of claim 9, wherein the random binding identification is a random number.

11. The method of claim 1, wherein the assigning step comprises the step of reading a table of contents of the content.

12. The method of claim 1, wherein the data is separated into at least two sections wherein each of the at least two sections includes a watermark embedded therein, wherein the watermark uniquely identifies the corresponding section.

13. The method of claim 12, further comprising the step of determining whether any of the watermarks contain a copy-never message.

14. The method of claim 12, further comprising the step of comparing a section identification number in a watermark embedded in one of the at least two sections with a section identification number in a watermark embedded in another one of the at least two sections to determine whether the two section identification numbers match.

15. The method of claim 14, further comprising the step of incrementing an error counter if the two section identification numbers do not match.

16. The method of claim 15, further comprising the step of destroying a random binding identification associated with the content, if the error counter exceeds the threshold number of errors.

17. The method of claim 14, further comprising the step of marking a watermark as unused if the section identification numbers do not match.

18. The method of claim 12, further comprising the step of counting the number of watermarks that have been evaluated.

19. The method of claim 18, further comprising the step of initiating a retry algorithm if the number of watermarks that have been evaluated is less than a predetermined number.

20. A method of determining a prevailing number within a set of numbers, the method comprising the steps of:
setting a prevailing number count equal to a first number count;
setting a value of the prevailing number equal to a value of the first number;
determining whether a next number count is greater than the prevailing number count;
setting the prevailing number count equal to the next number count if the next number count is greater than the prevailing number count; and
repeating the determining step and the third setting step until each of the numbers within the set of numbers has been evaluated.

21. The method as recited in claim 20, further comprising the step of determining a quantity of numbers that are not equal to the prevailing number.

22. An apparatus for verifying the presence of original data on content comprising:
a processing device having a processor coupled to a memory, the processing device being operative to collect data associated with the content; evaluate the collected data to verify the presence of original data in the content; and reject the content if a number of errors detected during the evaluating step exceeds a threshold number of errors.
